(19) United States
(12) Patent Application Publication
(10) Pub. No.: US 2016/0229161 A1
(43) Pub. Date: Aug. 11, 2016

(54) WOOD-PLASTIC PVC FLOORBOARD

(71) Applicant: Xiaoling ZHANG, Jiangsu (CN)

(72) Inventors: Xiaoling Zhang, Changzhou (CN); Zhiyuan Xiao, Changzhou (CN)

(73) Assignee: Xiaoling Zhang, Changzhou (CN)

(21) Appl. No.: 15/022,599

(22) PCT Filed: Apr. 4, 2014
(86) PCT No.: PCT/CN2014/074794

§ 371 Date: Mar. 17, 2016

(30) Foreign Application Priority Data
Dec. 19, 2013 (CN) 201320838335.1

(51) Int. Cl. B32B 27/30; B32B 21/08; B32B 7/12; E04F 15/02; E04F 15/10

(52) U.S. Cl. CPC B32B 27/304; E04F 15/02038; E04F 15/107; E04F 15/102; B32B 7/12; B32B 21/08; B32B 2471/00; B32B 2307/554; B32B 2307/75

(57) ABSTRACT

A wood-plastic PVC floorboard comprises a PVC main body layer and an underlying substrate wood-plastic layer. The PVC main body layer and the wood-plastic layer are stuck together through glue. Lock structures are arranged at two sides of the wood-plastic layer for bonding two adjacent floorboards. Materials adopted by the wood-plastic layer are wood powder, PVC resin powder and stone powder. Water resistance of wood-plastic and flexibility and water resistance of PVC are combined together. An overall product is not only lighter than a prior lock PVC in a mass, but also more stable than the prior lock PVC, and is easier to install. The total product is water-resistant, without a formaldehyde problem of laminate floorboards.

### BACKGROUND OF THE INVENTION

1. Field of the Invention

The present invention relates to a PVC floorboard, and more particularly to a wood-plastic PVC floorboard.

2. Description of the Prior Art

A prior lock-type PVC floorboard is very sensitive to temperature because of the characteristic of PVC material, so it is easy to be wrapped in a high temperature environment, or easy to be unhooked due to a softened lock structure under the high temperature and a material shrinkage under a later temperature reduction. Therefore, an applying environment of the prior lock-type PVC floorboard must be strict to control temperature, and this will greatly restrict the applying place of the lock-type PVC floorboard. Further for an aggrandizement floorboard, i.e. an impregnated paper laminating wood floorboard or a product including an HDF (High Density Fiberboard) the substrate and a PVC attached to the HDF, the applying place thereof is also greatly restricted because the material is not waterproof.

### BRIEF SUMMARY OF THE INVENTION

In order to overcome the defects of the prior art, the present invention provides a wood-plastic PVC floorboard, which is waterproof, has more stable lock structures and can be more easily assembled.

To achieve the above object of the present invention, the present invention adopts the following technical solution.

A wood-plastic PVC floorboard comprises a PVC main body layer and an underlying substrate wood-plastic layer. The PVC main body layer and the wood-plastic layer are stuck together through glue. The wood-plastic layer disposes lock structures separately located at two sides thereof for combining two adjacent wood-plastic PVC floorboards together.

Further, materials adopted by the wood-plastic layer are wood powder, PVC resin powder and stone powder.

Further, the main body layer includes a PU coating, a wear-resisting layer, a printing layer and a PVC material layer.

The present invention has the beneficial effects of: integrating the advantages of the two materials by combining the PVC main body layer with the wood-plastic layer.

1. Good Water resistance: because both the PVC main body layer and the wood-plastic layer adopt water resistance materials, the whole water resistance effect is excellent.

2. High stability: the lock structures are disposed on the wood-plastic layer and are made of wood powder, PVC resin powder and stone powder. Because the material is not sensitive to temperature, the change of temperature has little effect on the hardness of the lock structures. In the case of temperature change, the lock structures still may keep hardness and tension thereof.

3. Easy installation: because the wood-plastic layer has high mechanic strength, it may be provided with straight-type lock structures or knocking-type lock structures that are more convenient to be installed.

4. Light weight: because the wood-plastic layer is foamed, the overall density is light. In the case of the same volume, the wood-plastic PVC floorboard is more than 60% lighter than the prior lock-type PVC floorboard.

### BRIEF DESCRIPTION OF THE DRAWINGS

FIG. 1 is a structural schematic view of a wood-plastic PVC floorboard of the present invention.

### REFERENCE NUMERALS

1 PU coating

10 PVC main body layer

1 wear-resisting layer

3 printing layer

4 PVC material layer

6 wood-plastic layer

61 lock structure

### DETAILED DESCRIPTION OF THE PREFERRED EMBODIMENTS

The following text will further describe the present invention with reference to the accompanying drawings.

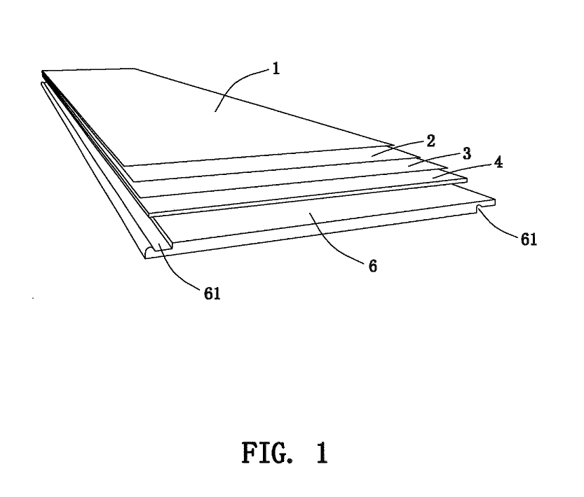

Please refer to FIG. 1, a wood-plastic PVC floorboard of the present invention from top to bottom includes a PVC main body layer 10 and an underlying substrate wood-plastic layer 6. The PVC main body layer 10 from top to bottom includes a PU coating 1, a wear-resisting layer 2, a printing layer 3 and a PVC material layer 4. The PU coating 1, the wear-resisting layer 2, the printing layer 3 and the PVC material layer 4 all adopt materials of the existing PVC floorboard. The wood-plastic layer 6 adopts materials of wood powder, PVC resin powder and stone powder. The wood-plastic layer 6 disposes lock structures 61 separately located at two sides thereof for combining two adjacent wood-plastic PVC floorboards together. The PVC main body layer 10 and the wood-plastic layer 6 are stuck together through glue. Therefore, by integrating the advantages of the two materials, water resistance of the wood-plastic layer and flexibility and water resistance of the PVC main body layer are combined together. An overall product is not only lighter than the prior lock-type PVC floorboard in a mass, but also more stable than the prior lock-type PVC floorboard, and is easier to install. The total product is water-resistant, without a formaldehyde problem of laminate floorboards.

The technical scope of the present invention is not limited to the above description of the contents. Any person who skilled in the art may deform and modify the embodiment of the present invention within the spirit and scope of the appended claims, but these deformation and modification belong to the protection scope of the present invention.

What is claimed is:

1. A wood-plastic PVC floorboard being characterized in that: comprising a PVC main body layer and an underlying substrate wood-plastic layer, the PVC main body layer and the wood-plastic layer being stuck together through glue; the wood-plastic layer disposing lock structures separately located at two sides thereof for combining two adjacent wood-plastic PVC floorboards together.

2. The wood-plastic PVC floorboard as claimed in claim 1, characterized in that: materials adopted by the wood-plastic layer are wood powder, PVC resin powder and stone powder.

3. The wood-plastic PVC floorboard as claimed in claim 1, characterized in that: the main body layer includes a PU coating, a wear-resisting layer, a printing layer and a PVC material layer.
